(19) United States
(12) Patent Application Publication
(10) Pub. No.: US 2018/0270789 A1
(43) Pub. Date: Sep. 20, 2018

(54) Updating Apparatus and Method for Access Control Parameter and Communication System

(71) Applicant: FUJITSU LIMITED, Kawasaki-shi (JP)

(72) Inventors: Meiyi JIA, Beijing (CN); Haibo XU, Beijing (CN); Wei XI, Beijing (CN)

(73) Assignee: FUJITSU LIMITED, Kawasaki-shi (JP)

(21) Appl. No.: 15/982,253

(22) Filed: May 17, 2018

Related U.S. Application Data
(63) Continuation of application No. PCT/CN2015/097584, filed on Dec. 16, 2015.

(51) Int. Cl. H04W 68/02; H04W 48/02; H04W 74/00; H04W 52/02

(52) U.S. Cl. CPC H04W 68/02; H04W 48/02; H04L 1/1614; H04W 52/0209; H04W 74/002

(57) ABSTRACT

An updating apparatus and method for an access control parameter and a communication system. The updating method includes: determining by a UE access class barring information for performing access control and update period information for updating the access class barring information; and updating the access class barring information by the UE based on the update period information. The UE itself improves fairness of the access, and the network side updates the access control parameter only when the network payload is modified, which may lower power consumption of the UE in access, avoid frequent occurrence of paging and reduce use of broadcast resources of the system.

### CROSS REFERENCE TO RELATED APPLICATIONS

This application is a continuation application of International Application PCT/CN2015/097584 filed on Dec. 16, 2015, the entire contents of which are incorporated herein by reference.

### TECHNICAL FIELD

This disclosure relates to the field of communication technologies, and in particular to an updating apparatus and method for an access control (AC) parameter and a communication system.

### BACKGROUND

In current wireless cellular systems, there are the following access control techniques: IP multimedia subsystem (IMS) traffic access control and data communication congestion control. The IMS traffic access control includes, for example, service-specific access control (SSAC), and access control barring-skip (ACB-skip), etc.

Data communication congestion control includes, for example, access class barring (ACB), extended access barring (EAB), and application-specific congestion control for data communication (ACDC).

In the ACB mechanism, a serving network (such as a serving network being implemented by a serving cell configured by a corresponding base station) broadcasts specific control information (such as a barring factor and a barring time) for connections of different connection types in system information (SI). A mobile terminal (or may be referred to as a user equipment (UE)) randomly acquires a random number from 0 to 1, then according to a connection type informed by a higher layer (such as a non-access stratum (NAS)), the UE determines whether this connection is barred by using control information (for example, the random number is compared with a barring factor) corresponding to the connection; if the UE determines that this connection is barred, it calculates an actual barred time according to a broadcasted barred time, the acquired random number and a formula provided in a protocol; and if the UE determines that this connection is not barred, it may initiate a connection establishment procedure to a lower layer (such as a medium access control (MAC) sub-layer),

In the EAB mechanism, the serving network broadcasts an access class-based bitmap information in the system information. Based on the access control class of itself and the broadcasted bitmap information, the UE determines whether the connection is barred, and terminates the connection establishment procedure if the connection is barred, otherwise, it may use the ACB mechanism.

In the ACDC mechanism, when a new access attempt is initiated in case of congestion, the UE considers specific applications that are predefined by operators as allowed or barred. A public land mobile network (PLMN) allocates different ACDC classes for different traffics with different priorities in the UE, and the serving network broadcasts control information (such as a barring factor and a barring time) for each ACDC class in the system information.

An access control parameter (such as the above access class-based bitmap information) is transmitted to a UE by a base station generally using a system information block (SIB). And current methods for updating and acquiring system information, for example, include:

(1) A normal update method: it is applicable for normal system information, such as SIB2 which is used for the ACB mechanism. In this method, a modification period of the system information is defined, and by paging or by broadcasting a value tag in SIB1 in a current modification period T₀, the UE is notified that the system information is to be modified; and in a next modification period T₁, the serving network will broadcast new system information, and the UE will receive the new system information within the modification period T₁.

(2) An immediate update method: it is applicable for system information requiring immediate update, such as SIB 14 used for EAB mechanism. In this method, the UE is notified via a paging message that the system information is modified, and corresponding system information is updated immediately; and after receiving the paging message, the UE immediately reads scheduling information and obtains new system information.

(3) A method of reading when needed: it is applicable for UEs which have possibility of long time dormancy, such as a UE configured with discontinuous reception (DRX) or enhanced DRX.

In this method, the serving network does not need to notify the modification of the system information and may update the system information at any time; but the UE is required to obtain again corresponding system information when needs each time (such as when a higher layer initiates a connection establishment procedure), without taking whether the system information is modified into account.

And on the other hand, more and more attention is paid to the study of the Internet of Things (IoT). Under a wireless cellular system, an IoT which has extremely low complexity and low throughput (which may be referred to as a narrow band IoT) needs to be supported. Performance objects of a narrow band IoT system include improved indoor coverage, support for a large amount of devices with low throughput, lowered complexity, and improved energy efficiency and latency, etc.

An access control parameter of the narrow band IoT may possibly be modified frequently, for example, a modification period of system information should be shorter than those of other systems. If the above normal update method or immediate update method is adopted, a UE without attempt for initiating a connection establishment procedure has to acquire access control parameters for multiple times unnecessarily, which goes against the performance objects of the narrow band IoT technique (such as improved energy efficiency). And if the above method of reading when needed is adopted, in a case where a higher layer frequently initiates connection establishment request and the access control parameter is not modified, the UE will also unnecessarily read the system information, thereby resulting in waste of energies.

Therefore, taking performance demands of, such as the narrow band IoT technique, into account, there is a need to enhance existing update and acquisition mechanisms of the access control parameter, so as to achieve a goal of energy saving.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

It was found by the inventors that causes for updating an access control parameter include, for example, change of a network payload, and ensuring fairness of access of UEs with different access classes. In existing schemes, the access control parameter is updated by the network side without differentiating the cause why the parameter is updated, which result in such problems as large power consumption of the UE in access, frequent paging occurrence, and a large amount of usage of the system broadcast resources, etc.

Embodiments of this disclosure provide an updating apparatus and method for an access control parameter and a communication system, in which fairness in access is improved by updating access class barring information by the UE, and the network side updates the access control parameter only when the network payload is modified without taking fairness into account, which may lower power consumption of the UE in access, avoid frequent occurrence of paging and reduce use of broadcast resources of the system.

According to a first aspect of the embodiments of this disclosure, there is provided an updating method for an access control parameter, the updating method including:

determining, by a UE, access class barring information for performing access control and update period information for updating the access class barring information; and

updating the access class barring information by the UE based on the update period information.

According to a second aspect of the embodiments of this disclosure, there is provided an updating apparatus for an access control parameter, configured in a UE, the updating apparatus including:

an information determining unit configured to determine access class barring information for performing access control and update period information for updating the access class barring information; and

an information updating unit configured to update the access class barring information based on the update period information.

According to a third aspect of the embodiments of this disclosure, there is provided an updating method for an access control parameter, the updating method including:

transmitting system information by a base station to a UE, the system information including access class barring information for performing access control and update period information for updating the access class barring information.

According to a fourth aspect of the embodiments of this disclosure, there is provided an updating apparatus for an access control parameter, configured in a base station, the updating apparatus including:

an information transmitting unit configured to transmit system information to a UE, the system information including access class barring information for performing access control and update period information for updating the access class barring information.

According to a fifth aspect of the embodiments of this disclosure, there is provided a communication system, including:

a UE, configured with the updating apparatus for an access control parameter as described in the second aspect.

An advantage of the embodiments of this disclosure exists in that the UE updates the access class barring information based on the update period information, so that the UE itself improves fairness of the access, and the network side updates the access control parameter only when the network payload is modified without taking fairness into account, which may lower power consumption of the UE in access, avoid frequent occurrence of paging and reduce use of broadcast resources of the system.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of this disclosure. To facilitate illustrating and describing some parts of the disclosure, corresponding portions of the drawings may be exaggerated or reduced.

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is a schematic diagram of the updating method for an access control parameter of Embodiment 1 of this disclosure;

FIG. 2 is another schematic diagram of the updating method for an access control parameter of Embodiment 1 of this disclosure;

FIG. 3 is a further schematic diagram of the updating method for an access control parameter of Embodiment 1 of this disclosure;

FIG. 4 is still another schematic diagram of the updating method for an access control parameter of Embodiment 1 of this disclosure;

FIG. 5 is a schematic diagram of the updating method for an access control parameter of Embodiment 2 of this disclosure;

FIG. 6 is a schematic diagram of the updating apparatus for an access control parameter of Embodiment 3 of this disclosure;

FIG. 7 is another schematic diagram of the updating apparatus for an access control parameter of Embodiment 3 of this disclosure;

FIG. 8 is a further schematic diagram of the updating apparatus for an access control parameter of Embodiment 3 of this disclosure;

FIG. 9 is a schematic diagram of the UE of Embodiment 3 of this disclosure;

FIG. 10 is a schematic diagram of the updating apparatus for an access control parameter of Embodiment 4 of this disclosure;

FIG. 11 is a schematic diagram of the base station of Embodiment 4 of this disclosure; and

FIG. 12 is a schematic diagram of the communication system of Embodiment 5 of this disclosure.

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

### Embodiment 1

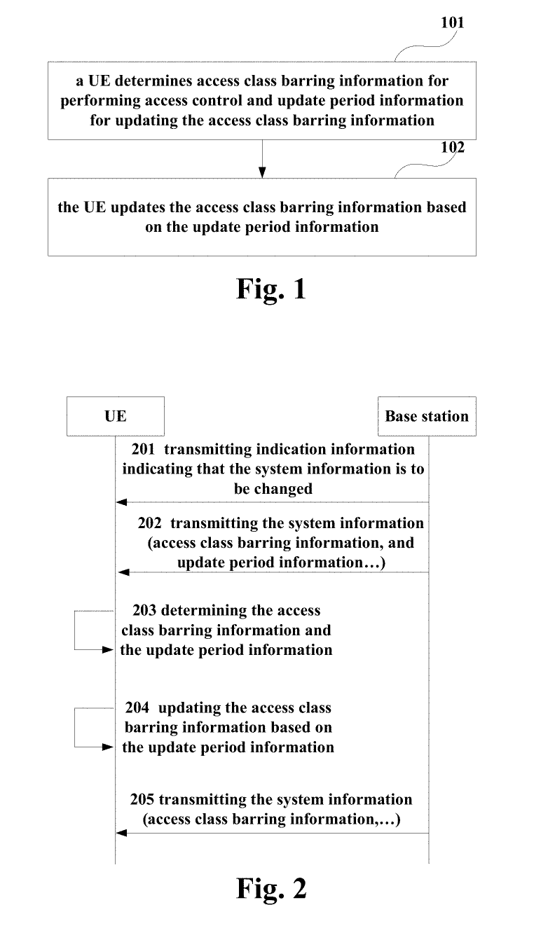

The embodiment of this disclosure provides an updating method for an access control parameter. FIG. 1 is a schematic diagram of the updating method for an access control parameter of the embodiment of this disclosure, which shall be described from a UE side. As shown in FIG. 1, the updating method includes:

Block 101: a UE determines access class barring information for performing access control and update period information for updating the access class barring information; and

Block 102: the UE updates the access class barring information based on the update period information.

In this embodiment, the UE may be, for example, a terminal of an NB-IoT (narrow band internet of things). However, this disclosure is not limited thereto; for example, the UE may also be a terminal of another network system. The UE may have a corresponding access class; for example, each UE is ex-work configured with an access class. The embodiments of this disclosure shall be described by taking an NB-LoT as an example only. However, this disclosure is not limited thereto, and it is also applicable to any system performing access control.

In this embodiment, the access class barring information may also be referred to as access class based barring information. The UE may receive system information including the access class barring information, and may determine the access class barring information from the system information. However, this disclosure is not limited thereto, and the UE may acquire the access class barring information in other manners, such as obtaining the access class barring information from another UE in a device to device (D2D) manner. And furthermore, the access class barring information may also be information prestored in the UE.

The base station in the embodiments of this disclosure may be a macro base station (such as an eNB), and UE may be served by a macro cell generated by the macro base station. And the base station in the embodiments of this disclosure may also be a pico base station, and UE may be served by a pico cell generated by the pico base station. However, this disclosure is not limited thereto, and a particular scenario may be determined according to an actual situation.

In this embodiment, the system information transmitted by the base station may further include the update period information, and the UE may determine the update period information from the system information. However, this disclosure is not limited thereto, and the UE may determine the update period information by itself, or the update period information is predefined, or is obtained from another UE in a D2D manner, etc.

What is different from the prior art is that in this embodiment, causes for updating the access control parameter are taken into account, and are differentiated. And the UE updates the access class barring information based on the update period information, thereby improving fairness in access by the UE itself. Hence, power consumption of the UE in access can be lowered, frequent occurrence of paging can be avoided, and use of broadcast resources of the system can be reduced.

The embodiment of this disclosure shall be further described by taking acquiring the access class barring information and the update period information from the base station (by using an EAB mechanism, for example) as an example. The access class barring information may be bitmap information including multiple bits, and reference may be made to the barring bitmap given in the residential access network (RAN2) in the relevant art, i.e. a parameter similar to that in the EAB. However, this disclosure is not limited thereto; for example, the access class barring information may adopt other representations.

FIG. 2 is another schematic diagram of the updating method for an access control parameter of the embodiment of this disclosure, which shall be described from the UE side and a base station side. As shown in FIG. 2, the updating method includes:

201: a base station transmits to a UE indication information indicating that the system information is to be changed.

In this embodiment, the above normal update method may be reused, that is, it is indicated in a current modification period that the system information is to be changed, such as notifying by paging or via a value tag contained in the system information; and a corresponding access control parameter is updated in a next modification period.

202: the base station transmits the system information to the UE; the system information includes access class barring information for performing access control and update period information for updating the access class barring information. In this embodiment, the access class barring information may be, for example, bitmap information consisting of 10 bits, denoting whether access classes 0-9 are barred. For example, the bitmap information is “0001000010”, denoting access class barring information for the access classes 0-9 from the right to the left. Hence, the above bitmap information denotes a UE of an access class 1 or 6 is barred in access, and a UE of access classes 0, 2, 3, 4, 5, 7, 8, or 9 is permitted in access. The update period information may be, for example, a value of an update period T, such as 40, denoting that the access class barring information is updated per 40 milliseconds.

The system information may further include other information, such as roaming information, a flag indicating whether event triggering report is controlled by access control, and a possible barring time, etc. Reference may be made to the relevant art for such information, which shall not be described herein any further.

203: the UE determines the access class barring information and the update period information based on the system information.

204: the UE updates the access class barring information based on the update period information.

In this implementation, the UE may perform shift operations on the multiple bits based on the update period information, so as to update the access class barring information. For example, it may calculate an update time according to a system frame number (SFN), that is, perform shift operations on the multiple bits at an SFN satisfying the condition, according to a formula SFN mod T=0.

For example, if the bitmap information is “0001000010” and the bitmap information is shifted leftwards by one bit by default, when the update time arrives, “0001000010” is updated into “0010000100”, denoting that a UE of an access class 2 or 7 is barred in access, and a UE of access classes 0, 1, 3, 4, 5, 6, 8, or 9 is permitted in access. Thus, not only the number of access classes permitted in access always keeps unchanged, but also opportunities for access of the access classes are equal, and fairness of access is improved.

It should be noted that the update of the access class barring information is described above by taking shift operations as examples only. However, this disclosure is not limited thereto, and other manners of update may also be used.

For example, the bitmap information “0001000010” may be divided into multiple groups, “00” “01” “00” “00” “10”, then the multiple groups are ordered to form the following sequence: “00” “00” “00” “10” “01”, thereby obtaining the updated “0000001001”. Or, positions of the bits of the bitmap information “0001000010” may be symmetrically exchanged to obtain “0100001000”, etc. This may ensure that the number of access classes permitted in access always keeps unchanged, and fairness of access is improved.

For another example, the access class barring information may also be updated based on a predefined value. For example, a predefined value “1000000000” may be prestored, and an XOR operation is performed on the bitmap information “0001000010” and the predefined value, so as to obtain the updated “1001000010”. Although the number of access classes permitted in access is changed, it may be ensured that the access class 9 is permitted in access every other period T.

How to update the access class barring information is illustrated above only; however, this disclosure is not limited thereto. For example, the update may also be performed according to a specific formula or rule, and those skilled in the art may obtain more implementations according to the above examples. The embodiment of this disclosure is not only limited to the above implementations, and any implementation may be covered by the scope of the embodiments of this disclosure only if a UE updates access class barring information.

In this implementation, in a case where the system information is not updated, the UE may execute 204 for multiple times, hence, the UE may update the access class barring information by itself. And in a case where the system information needs to be updated (for example, a network payload is changed), the updating method may further include:

205: the base station transmits to the UE the system information including the access class barring information.

In this implementation, the UE may update the access class barring information according to the system information, and the existing EAB mechanism may be referred to for details. Then the UE may continue updating the access class barring information by itself as described in 203 and 204 according to the update period information obtained in 202.

That is, the update period information may only be contained in one or more updates of the system information, and is transmitted by the base station to the UE; and in a case where the system information does not contain the update period information, the UE continues using the previous update period information. Furthermore, the update period information may be contained in each update of the system information, and is transmitted by the base station to the UE; and after receiving the update period information, the UE may calculate the update time again and update the access class barring information according to a new update period.

In the implementation shown in FIG. 2, shift operations may be performed according to default shift number information and shift direction information. In this embodiment, the shift number information and/or the shift direction information may also be determined by the UE, only if an agreement is made between the UE and the base station; or the shift number information and/or the shift direction information may be transmitted by the base station.

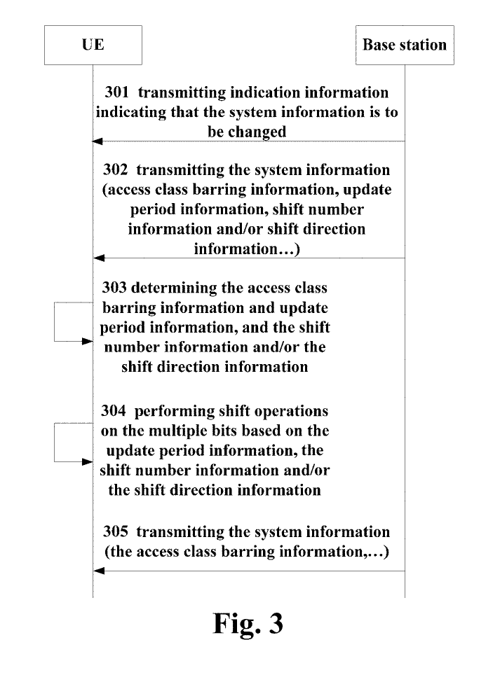

FIG. 3 is a further schematic diagram of the updating method for an access control parameter of the embodiment of this disclosure, which shall be described from the UE side and the base station side. As shown in FIG. 3, the updating method includes:

301: the base station transmits to the UE indication information indicating that the system information is to be changed.

302: the base station transmits the system information to the UE; the system information includes access class barring information for performing access control and update period information for updating the access class barring information, and it further includes shift number information and/or shift direction information used for updating the access class barring information.

In this implementation, the access class barring information may be, for example, bitmap information consisting of 10 bits, denoting whether access classes 0-9 are barred in access. For example, the bitmap information is “0001000010”, denoting that a UE of an access class 1 or 6 is barred in access, and a UE of access classes 0, 2, 3, 4, 5, 7, 8, or 9 is permitted in access. The update period information may be, for example, a value of an update period T, such as 40, denoting that the access class barring information is updated per 40 milliseconds.

The system information may further include shift number information and/or shift direction information. The shift number information is, for example, a value of a shift number N, such as 2, denoting being shifted by 2 bits. And the shift direction information is, for example, a value of a shift direction S, such as 1, denoting being shifted leftwards, or such as 0, denoting being shifted rightwards.

303: the UE determines the access class barring information and update period information, and the shift number information and/or the shift direction information, based on the system information.

304: the UE performs shift operations on the multiple bits based on the update period information, the shift number information and/or the shift direction information, so as to update the access class barring information.

For example, if the bitmap information is “0001000010”, the shift number N indicated by the shift number information is 2 and the shift direction S indicated by the shift direction information is 0, when the update time arrives, the bitmap information is shifted rightwards by 2 bits, and “0001000010” may be updated into “1000010000”, denoting that a UE of an access class 4 or 9 is barred in access, and a UE of access classes 0, 1, 2, 3, 5, 6, 7, or 8 is permitted in access, thereby improving fairness of access.

For another example, if the bitmap information is “0001000010” and the shift number N indicated by the shift number information is 2, when the update time arrives, the bitmap information is shifted leftwards by 2 bits by default, and “0001000010” may be updated into “0100001000”, denoting that a UE of an access class 3 or 8 is barred in access, and a UE of access classes 0, 1, 2, 4, 5, 6, 7, or 9 is permitted in access, thereby improving fairness of access.

In this implementation, in a case where the system information is not updated, the UE may execute 304 for multiple times, hence, the UE may update the access class barring information by itself. And in a case where the system information needs to be updated (for example, a network payload is changed), the updating method may further include:

305: the base station transmits to the UE the system information including the access class barring information.

It should be noted that the update period information, the shift number information and/or the shift direction information in this implementation are transmitted via the system information in 302. However, this disclosure is not limited thereto; for example, they may be respectively transmitted in multiple steps.

In this embodiment, the change of the access control parameter resulted from the network payload, etc. is described in FIGS. 2 and 3 by taking the normal update method as an example. However, this disclosure is not limited thereto, and the above-described immediate update method and method of reading when needed may also be used.

In this embodiment, the access control information may not be changed within the update period T, and when the time to which the update period T corresponds arrives, the UE may perform shift operations on the access control information, so as to ensure fairness between different access classes. Such a change is not controlled by existing update of the system information, that is, it does not need to be informed by the network side to the UE by paging or via a value tag or other means. And if the network side performs update on information other than the access class barring information, an existing update mechanism may be reused.

It is illustrated above that the UE side updates the access class barring information by itself and the network side transmits the system information. And for the system information transmitted by the network side, the UE side may acquire it only in need.

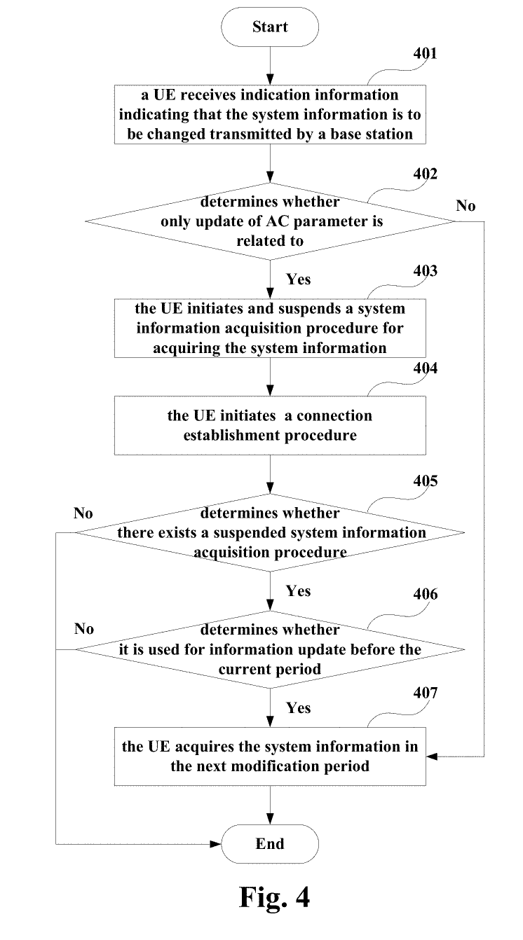

FIG. 4 is a schematic diagram of acquiring the system information of the embodiment of this disclosure, which shall be described from a UE side. For the sake of simplicity, contents of updating the access class barring information by the UE side itself are not shown, and FIGS. 1-3 may be referred to for these contents. As shown in FIG. 4, the updating method includes:

Block 401: the UE receives indication information transmitted by the base station and indicating that the system information is to be changed;

in this implementation, the above normal update method may be reused, that is, it is indicated in a current modification period that the system information is to be changed, such as notifying by paging or via a value tag contained in the system information; and corresponding access control information is updated in a next modification period.

Block 402: the UE determines whether a change of the system information relates only to update of the access control parameter, and executes block 403 when the change of the system information relates only to update of the access control parameter, otherwise, executes block 407 in a next modification period, that is, following the existing normal update method;

in this implementation, if the UE is unable to determine whether the change of the system information relates only to update of the access control parameter, block 407 may be executed, that is, the existing normal update method is still followed.

Block 403: the UE initiates and suspends a system information acquisition procedure for acquiring the system information;

in this implementation, what is different from the prior art is that when the change of the system information relates only to update of the access control parameter, the UE does not acquire the system in the next modification period, but suspends the system information acquisition procedure.

Block 404: the UE initiates a connection establishment procedure.

Block 405: the UE determines whether there exists a suspended system information acquisition procedure, and executes block 406 when there exists a suspended system information acquisition procedure.

Block 406: the UE determines whether the suspended system information acquisition procedure is used for information update before the current period, and executes block 407 when the suspended system information acquisition procedure is used for information update before the current period; and

Block 407: the UE acquires the system information in the next modification period.

In this implementation, whether there exists a suspended system information acquisition procedure is determined only when a higher layer of the UE requests for initiating the connection establishment procedure, that is, needing to acquire the system information; and the system information is acquired only when there exists a suspended system information acquisition procedure and the suspended system information acquisition procedure is used for information update before the current modification period, and then access control check is performed.

When there exists no suspended system information acquisition procedure, or the suspended system information acquisition procedure is not used for information update before the current modification period, the UE does not acquire the system information, and it may update the access class barring information or perform the access control check on its own according to existing parameters.

In this implementation, the normal update method and the method of reading when needed may be combined to acquire the system information. Hence, for a UE not intending to initiate a connection establishment procedure, it will not unnecessarily acquire the system information for multiple times; and in a case where a higher layer frequently initiates connection establishment requests while the access control parameter is not changed, the UE will not unnecessarily read the system information. And furthermore, a wrap around problem possibly occurring in the normal update method may be avoided.

It should be noted that FIGS. 2-4 only schematically explains the embodiment of this disclosure; however, this disclosure is not limited thereto. For example, an order of execution of the blocks or steps may be appropriately adjusted, and furthermore, some other blocks or steps may be added, or some of these blocks or steps may be reduced.

Furthermore, although it is not shown in the figures of this embodiment, it should be understood by those skilled in the art that the update of the access class barring information and the acquisition of the system information in the UE may be performed in parallel, or separately. And appropriate modifications may be made by those skilled in the art according to what is described above, without being limited to those contained in FIGS. 1-4.

It can be seen from the above embodiment that the UE updates the access class barring information based on the update period information, so that the UE itself improves fairness of the access, and the network side updates the access control parameter only when the network payload is modified without taking fairness into account, which may lower power consumption of the UE in access, avoid frequent occurrence of paging and reduce use of broadcast resources of the system.

### Embodiment 2

The embodiment of this disclosure provides an updating method for an access control parameter, applicable to a base station, with contents identical to those in Embodiment 1 being not going to be described herein any further.

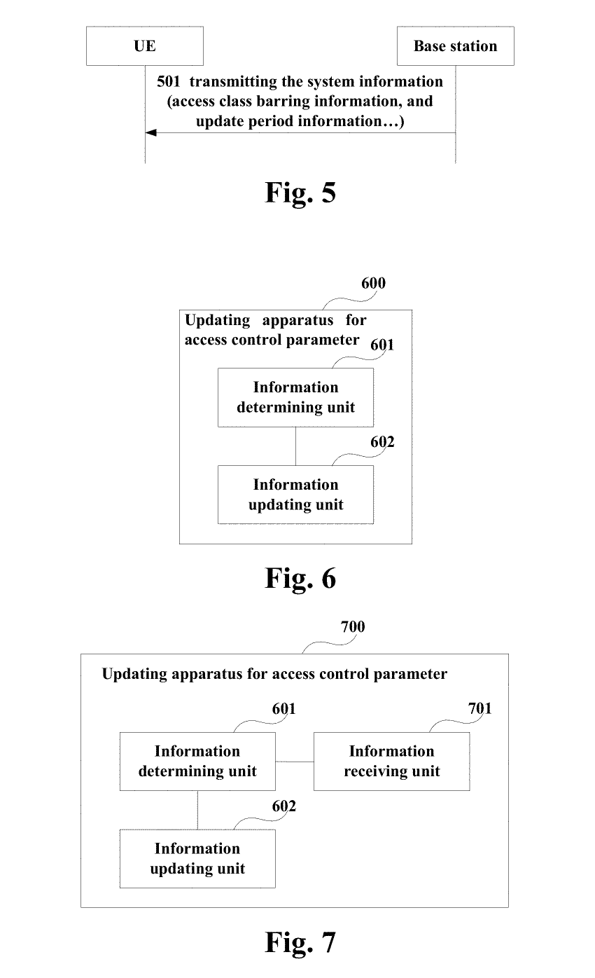

FIG. 5 is a schematic diagram of the updating method for an access control parameter of the embodiment of this disclosure. As shown in FIG. 5, the updating method includes:

501: a base station transmits system information to a UE, the system information including access class barring information for performing access control and update period information for updating the access class barring information.

In this embodiment, the access class barring information may be bitmap information including multiple bits. And furthermore, the system information may further include shift number information and/or shift direction information used for updating the access class barring information.

In this embodiment, reference may be made to the relevant art for how to transmit the system information; and furthermore, FIGS. 2-4 in Embodiment 1 may be referred to, which shall not be described herein any further.

It can be seen from the above embodiment that the base station transmits the access class barring information and the update period information to the UE, the UE updates the access class barring information based on the update period information, so that the UE itself improves fairness of the access, and the network side updates the access control parameter only when the network payload is modified without taking fairness into account, which may lower power consumption of the UE in access, avoid frequent occurrence of paging and reduce use of broadcast resources of the system.

### Embodiment 3

The embodiment of this disclosure provides an updating apparatus for an access control parameter, configured in a UE. The embodiment of this disclosure corresponds to the updating method for an access control parameter in Embodiment 1, with contents identical to those in Embodiment 1 being not going to be described herein any further.

FIG. 6 is a schematic diagram of the updating apparatus for an access control parameter of the embodiment of this disclosure. As shown in FIG. 6, the updating apparatus 600 for an access control parameter includes:

an information determining unit 601 configured to determine access class barring information for performing access control and update period information for updating the access class barring information; and

an information updating unit 602 configured to update the access class barring information based on the update period information.

In this embodiment, the access class barring information may be bitmap information including multiple bits, and reference may be made to the barring bitmap in the relevant art, i.e. a parameter similar to that in the EAB. However, this disclosure is not limited thereto; for example, the access class barring information may adopt other representations.

In one implementation, the information updating unit 602 may be configured to perform shift operations on the multiple bits based on the update period information, so as to update the access class barring information.

In another implementation, the information updating unit 602 may further be configured to determine shift number information and/or shift direction information used for updating the access class barring information; and the information updating unit 602 may further be configured to perform shift operations on the multiple bits based on the update period information, the shift number information and/or the shift direction information, so as to update the access class barring information.

For example, the update period information indicates an update period T, the shift number information indicates a shift number N, and the shift direction information indicates a shift direction S; and the information updating unit 602 shifts the multiple bits to the S by N bits when the T arrives.

FIG. 7 is another schematic diagram of the updating apparatus for an access control parameter of the embodiment of this disclosure. As shown in FIG. 7, the updating apparatus 700 for an access control parameter includes an information determining unit 601 and an information updating unit 602, as described above.

As shown in FIG. 7, the updating apparatus 700 for an access control parameter may further include:

an information receiving unit 701 configured to receive system information transmitted by a base station and including the access class barring information.

In one implementation, the system information may further include the update period information.

In another implementation, the system information may further include shift number information and/or shift direction information used for updating the access class barring information.

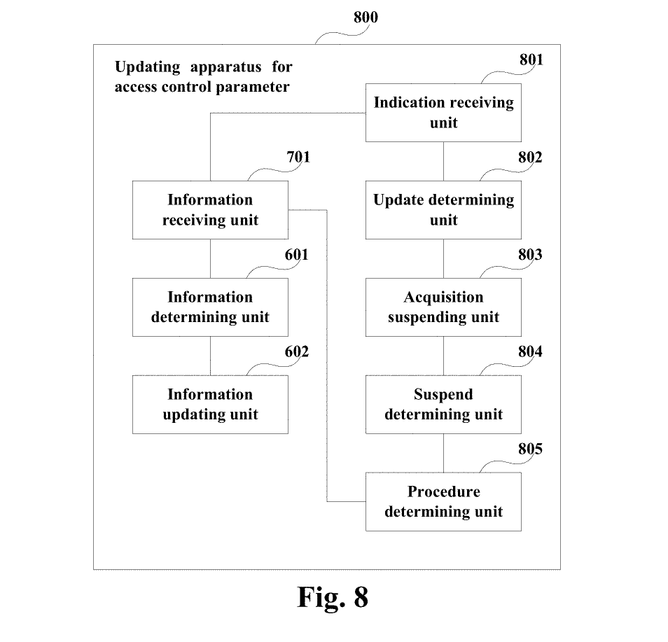

FIG. 8 is a further schematic diagram of the updating apparatus for an access control parameter of the embodiment of this disclosure. As shown in FIG. 8, the updating apparatus 800 for an access control parameter includes an information determining unit 601, an information updating unit 602 and an information receiving unit 701, as described above.

As shown in FIG. 8, the updating apparatus 800 for an access control parameter may further include:

an indication receiving unit 801 configured to receive indication information transmitted by the base station and indicating that the system information is to be changed;

an update determining unit 802 configured to determine whether a change of the system information relates only to update of the access control parameter; and

an acquisition suspending unit 803 configured to initiate and suspend a system information acquisition procedure for acquiring the system information when the change of the system information relates only to the update of the access control parameter.

As shown in FIG. 8, the updating apparatus 800 for an access control parameter may further include:

a suspend determining unit 804 configured to determine whether there exists a suspended system information acquisition procedure when the UE initiates a connection establishment procedure; and

a procedure determining unit 805 configured to determine whether the suspended system information acquisition procedure is used for information update before the current period, when there exists a suspended system information acquisition procedure;

and the information receiving unit 701 may further be configured to acquire the system information when the suspended system information acquisition procedure is used for information update before the current period.

This embodiment further provides a UE, configured with the above-described updating apparatus 600, or 700, or 800 for an access control parameter.

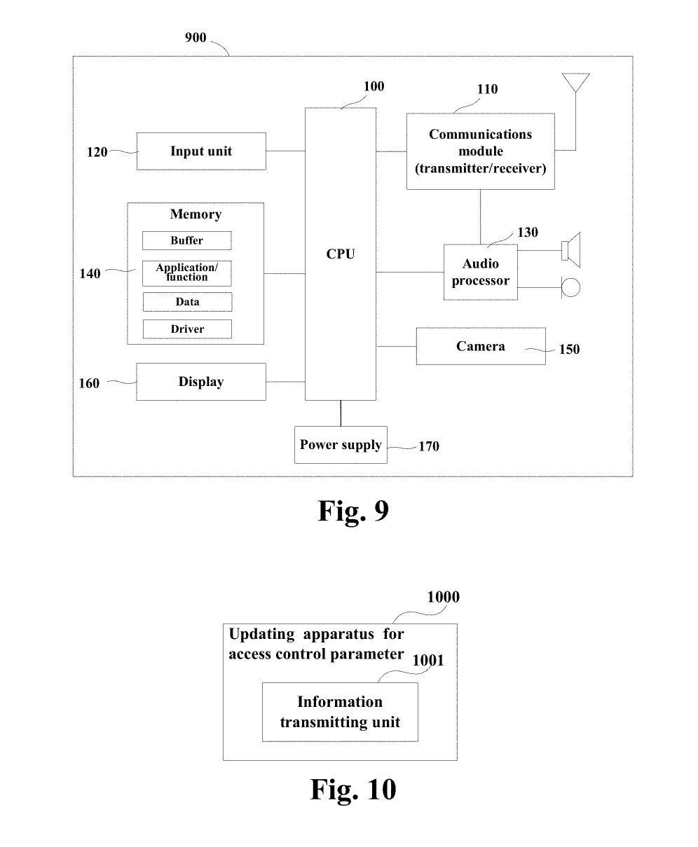

FIG. 9 is a schematic diagram of the UE of the embodiment of this disclosure. As shown in FIG. 9, the UE 900 may include a central processing unit 100 and a memory 140, the memory 140 being coupled to the central processing unit 100. It should be noted that this figure is illustrative only, and other types of structures may also be used, so as to supplement or replace this structure and achieve a telecommunications function or other functions.

In one implementation, the functions of the updating apparatus 600, or 700, or 800 for an access control parameter may be integrated into the central processing unit 100. The central processing unit 100 may be configured to carry out the updating method for an access control parameter described in Embodiment 1.

For example, the central processing unit 100 may be configured to perform the following control: determining access class barring information for performing access control and update period information for updating the access class barring information; and updating the access class barring information based on the update period information.

In another implementation, the updating apparatus 600, or 700, or 800 for an access control parameter and the central processing unit 100 may be configured separately. For example, the updating apparatus 600, or 700, or 800 for an access control parameter may be configured as a chip connected to the central processing unit 100, with its functions being realized under control of the central processing unit 100.

As shown in FIG. 9, the UE 900 may further include a communication module 110, an input unit 120, an audio processor 130, a memory 140, a camera 150, a display 160 and a power supply 170. Functions of the above components are similar to those in the relevant art, and shall not be described herein any further. It should be noted that the UE 900 does not necessarily include all the parts shown in FIG. 9, and furthermore, the UE 900 may include parts not shown in FIG. 9, and the relevant art may be referred to.

It can be seen from the above embodiment that the UE updates the access class barring information based on the update period information, so that the UE itself improves fairness of the access, and the network side updates the access control parameter only when the network payload is modified without taking fairness into account, which may lower power consumption of the UE in access, avoid frequent occurrence of paging and reduce use of broadcast resources of the system.

### Embodiment 4

The embodiment of this disclosure provides an updating apparatus for an access control parameter, configured in a base station. The embodiment of this disclosure corresponds to the updating method for an access control parameter in Embodiment 2, with contents identical to those in embodiments 1 and 2 being not going to be described herein any further.

FIG. 10 is a schematic diagram of the updating apparatus for an access control parameter of the embodiment of this disclosure. As shown in FIG. 10, the updating apparatus 1000 for an access control parameter includes:

an information transmitting unit 1001 configured to transmit system information to a UE, the system information including access class barring information for performing access control and update period information for updating the access class barring information.

In this embodiment, the access class barring information may be bitmap information including multiple bits. And furthermore, the system information may include shift number information and/or shift direction information used for updating the access class barring information.

In this embodiment, reference may be made to the relevant art for how to transmit the system information; and furthermore, FIGS. 2-4 in Embodiment 1 may be referred to, which shall not be described herein any further.

The embodiment of this disclosure further provides a base station, configured with the above-described updating apparatus 1000 for an access control parameter.

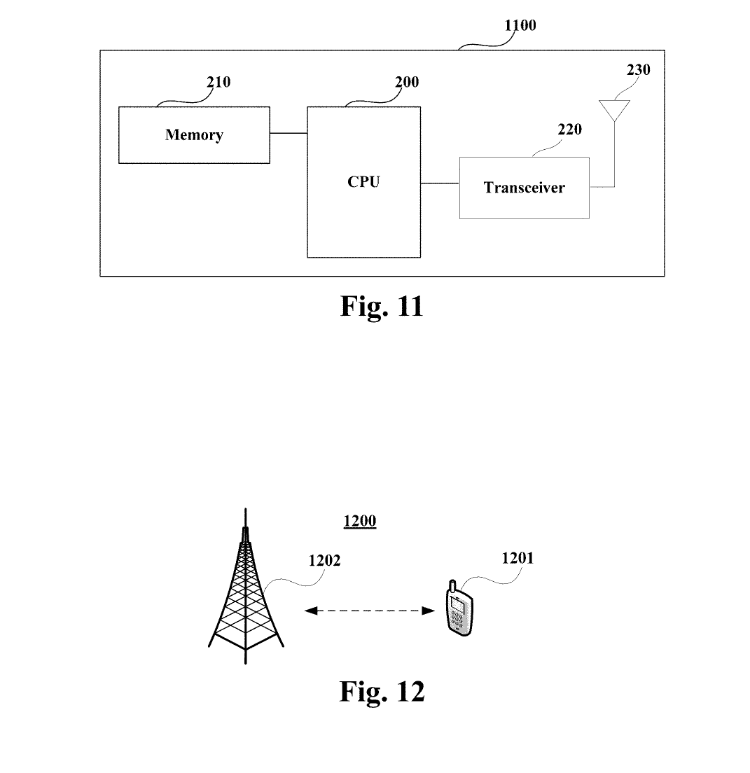

FIG. 11 is a schematic diagram of the base station of the embodiment of this disclosure. As shown in FIG. 11, the base station 1100 may include a central processing unit (CPU) 200 and a memory 210, the memory 210 being coupled to the central processing unit 200. The memory 210 may store various data, and furthermore, it may store a program for information processing, and execute the program under control of the central processing unit 200.

The base station 1100 may carry out the updating method for an access control parameter described in Embodiment 2. And the central processing unit 200 may be configured to carry out the functions of the updating apparatus 1000 for an access control parameter.

For example, the central processing unit 200 may be configured to perform the following control: transmitting system information to a UE, the system information including access class barring information for performing access control and update period information for updating the access class barring information.

Furthermore, as shown in FIG. 11, the base station 1100 may include a transceiver 220, and an antenna 230, etc. Functions of the above components are similar to those in the relevant art, and shall not be described herein any further. It should be noted that the base station 1100 does not necessarily include all the parts shown in FIG. 11, and furthermore, the base station 1100 may include parts not shown in FIG. 11, and the relevant art may be referred to.

It can be seen from the above embodiment that the base station transmits the access class barring information and the update period information to the UE, the UE updates the access class barring information based on the update period information, so that the UE itself improves fairness of the access, and the network side updates the access control parameter only when the network payload is modified without taking fairness into account, which may lower power consumption of the UE in access, avoid frequent occurrence of paging and reduce use of broadcast resources of the system.

### Embodiment 5

The embodiment of this disclosure provides a communication system, with contents identical to those in embodiments 1-4 being not going to be described herein any further.

FIG. 12 is a schematic diagram of the communication system of the embodiment of this disclosure. As shown in FIG. 12, the communication system 1200 includes a UE 1201 and a base station 1202.

In this embodiment, the UE 1201 may be configured with the updating apparatus 600, or 700 or 800 for an access control parameter as described in Embodiment 3, that is, the UE 1201 may be configured to: determine access class barring information for performing access control and update period information for updating the access class barring information; and update the access class barring information based on the update period information.

In one implementation, the base station 1202 may be an existing network side device (such as an eNB), and the UE 1201 may determine the update period information by itself, or the update period information is predefined, or may be obtained from another UE in a D2D manner, etc.

In another implementation, the base station 1202 may be configured with the updating apparatus 1000 for an access control parameter as described in Embodiment 4, that is, the base station 1202 may be configured to: transmit system information to the UE 1201, the system information including access class barring information for performing access control and update period information for updating the access class barring information.

An embodiment of the present disclosure provides a computer readable program code, which, when executed in a UE, will cause a computer unit to carry out the updating method for an access control parameter described in Embodiment 1 in the UE.

An embodiment of the present disclosure provides a computer readable medium, including a computer readable program code, which will cause a computer unit to carry out the updating method for an access control parameter described in Embodiment 1 in a UE.

An embodiment of the present disclosure provides a computer readable program code, which, when executed in a base station, will cause a computer unit to carry out the updating method for an access control parameter described in Embodiment 2 in the base station.

An embodiment of the present disclosure provides a computer readable medium, including a computer readable program code, which will cause a computer unit to carry out the updating method for an access control parameter described in Embodiment 2 in a base station.

The above apparatuses of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the spirits and principle of the present disclosure, and such variants and modifications fall within the scope of the present disclosure.

What is claimed is:

1. An updating apparatus for an access control parameter, configured in a user equipment (UE), the updating apparatus comprising:
an information determining unit configured to determine access class barring information for performing access control and update period information for updating the access class barring information; and
an information updating unit configured to update the access class barring information based on the update period information.

2. The updating apparatus according to claim 1, wherein the access class barring information is bitmap information comprising multiple bits.

3. The updating apparatus according to claim 2, wherein the information updating unit is configured to perform shift operations on the multiple bits based on the update period information, to update the access class barring information.

4. The updating apparatus according to claim 2, wherein the information updating unit is further configured to determine shift number information and/or shift direction information used for updating the access class barring information.

5. The updating apparatus according to claim 4, wherein the information updating unit is configured to perform shift operations on the multiple bits based on the update period information, the shift number information and/or the shift direction information, to update the access class barring information.

6. The updating apparatus according to claim 5, wherein the update period information indicates an update period T, the shift number information indicates a shift number N, and the shift direction information indicates a shift direction S;
and the information updating unit is configured to shift the multiple bits to the S by N bits when the T arrives.

7. The updating apparatus according to claim 1, wherein the updating apparatus further comprises:
an information receiving unit configured to receive system information, transmitted by a base station, the system information comprising the access class barring information.

8. The updating apparatus according to claim 7, wherein the system information further comprises the update period information.

9. The updating apparatus according to claim 8, wherein the system information further comprises shift number information and/or shift direction information used for updating the access class barring information.

10. The updating apparatus according to claim 7, wherein the updating apparatus further comprises:
an indication receiving unit configured to receive indication information, transmitted by the base station, the indication information indicating that the system information is to be changed;
an update determining unit configured to determine whether a change of the system information relates only to update of the access control parameter; and
an acquisition suspending unit configured to initiate and suspend a system information acquisition procedure for acquiring the system information when the change of the system information relates only to the update of the access control parameter.

11. The updating apparatus according to claim 10, wherein the updating apparatus further comprises:
a suspend determining unit configured to determine whether there exists a suspended system information acquisition procedure when the UE initiates a connection establishment procedure; and
a procedure determining unit configured to determine whether the suspended system information acquisition procedure is used for information update before the current period, when there exists a suspended system information acquisition procedure;
and the information receiving unit is further configured to acquire the system information when the suspended system information acquisition procedure is used for information update before the current period.

12. An updating apparatus for an access control parameter, configured in a base station, the updating apparatus comprising:
an information transmitting unit configured to transmit system information to a UE, the system information comprising access class barring information for performing access control and update period information for updating the access class barring information.

13. The updating apparatus according to claim 12, wherein the access class barring information is bitmap information comprising multiple bits.

14. The updating apparatus according to claim 12, wherein the system information further comprises shift number information and/or shift direction information used for updating the access class barring information.

15. A communication system, comprising:
a user equipment (UE) configured with the updating apparatus for an access control parameter as claimed in claim 1.

16. The communication system according to claim 15, wherein the communication system further comprises:
a base station configured with a updating apparatus for an access control parameter configured in a base station, the updating apparatus comprising:
an information transmitting unit configured to transmit system information to a UE, the system information comprising access class barring information for performing access control and update period information for updating the access class barring information.
